(19) United States
(12) Patent Application Publication
(10) Pub. No.: US 2011/0128665 A1
(43) Pub. Date: Jun. 2, 2011

(54) Ceramic Capacitors for High Temperature Applications

(75) Inventor: Craig W. Nies, Myrtle Beach, SC (US)

(73) Assignee: AVX CORPORATION, Myrtle Beach, SC (US)

(21) Appl. No.: 12/627,143

(22) Filed: Nov. 30, 2009

(51) Int. Cl. H01G 4/12; H01G 9/00; H01G 4/30; H01G 4/008

(52) U.S. Cl. 361/301.4; 427/80; 361/321.5; 361/305; 361/321.4

(57) ABSTRACT

A ceramic capacitor having a ceramic dielectric layer positioned between a first electrode layer and a second electrode layer and methods of manufacturing the same are provided. The ceramic dielectric layer includes a niobium doped barium titanate, a sodium bismuth titanate, and barium zirconate. The niobium doped barium titanate is present in an amount such that the ceramic dielectric layer includes from about 5% by weight to about 50% by weight barium titanate and from about 0.1% by weight to about 2% by weight niobium. The sodium bismuth titanate is present in the ceramic dielectric layer in an amount from about 25% by weight to about 75% by weight, and the barium zirconate is present in an amount from about 5% by weight to about 30% by weight.

### BACKGROUND

Multilayer ceramic capacitors are widely used as highly reliable compact electronic devices that include ceramic dielectric material having the general perovskite structure ABO₃, where A and B are cations. Of these devices, barium titanate-based dielectric layers have been widely used in high performance capacitor applications due to their relatively stable performance over a wide range of temperatures. Many currently available X7R capacitors, for example, are barium titanate-based capacitors. As is known in the art, the classification of these X7R capacitors is defined by their performance over their working temperature range, where “X” signifies the low end of the range (−55° C.), “7” signifies the upper end of the range (125° C.), and “R” signifies the tolerance over the range (+/−15% compared to the room temperature value).

Current demands require these multilayer ceramic capacitors to perform in increasingly elevated temperature environments, especially for uses in technologies areas of automobile, aerospace, deep drilling, electrical power grids, etc. However, current ceramic capacitors utilizing a barium titanate-based dielectic layer (e.g., the X7R capacitors described above) generally do not have sufficient performance for use in these elevated temperatures, mainly due to loss of capacitance above 125° C. The value of the dielectric constant of current barium titanate-based dielectric layers tends to fall dramatically once the operating temperature rises over 125° C. The loss of capacitance in these barium titanate-based devices results from the Curie temperature (“T_{C}”) of barium titanate of about 125° C., which effectively limits its usefulness as a dielectic material in higher temperature applications. The Curie temperature (or Curie point) refers to the temperature above which the material loses its spontaneous polarization and piezoelectric characteristics. Above the T_{C}, there is no little or no net dipole moment resulting in little or no spontaneous polarization.

Some high temperature electroceramic materials are known which have isolated high dielectric performance over a limited temperature range but very low dielectric constant at temperatures in the lower end of the temperature range. For instance, lead titanate is an excellent dielectric in the very close vicinity of its 490° C. phase transition temperature. However, these lead titanate-based dielectric layers may not have sufficient performance in lower temperature ranges, which inhibits their use in many applications. The environmental concerns of lead-based materials also limit the commercial viability of lead-based devices.

Sodium bismuth titanate has also emerged as a material that can possibly be utilized in high temperature capacitor applications. Current sodium bismuth titanate-based ceramic dielectric layers, however, suffer from radical variances in their dielectric constant throughout a wide temperature range (e.g., from about −55° C. to about 200° C.). Thus, the commercial viability of capacitors utilizing such sodium bismuth titanate-based ceramic dielectric layers is limited in applications where relative uniform performance over the entire temperature range of the capacitor is required.

A need therefore exists for a capacitor having a ceramic dielectric layer that has relatively low variation in its dielectric constant through a wide temperature range. Specifically, a need exists to expand the upper temperature limit of current X7R multilayer ceramic capacitors to about 200° C. or more.

### SUMMARY

Objects and advantages of the invention will be set forth in part in the following description, or may be obvious from the description, or may be learned through practice of the invention.

The present invention is directed to, in one embodiment, a ceramic capacitor having a ceramic dielectric layer positioned between a first electrode layer and a second electrode layer. The ceramic dielectric layer includes niobium doped barium titanate, sodium bismuth titanate, and barium zirconate. The niobium doped barium titanate is present in an amount such that the ceramic dielectric layer comprises from about 5% by weight to about 50% by weight barium titanate and from about 0.1% by weight to about 2% by weight niobium based on the weight of niobium material added. Sodium bismuth titanate is present in the ceramic dielectric layer in an amount from about 25% by weight to about 75% by weight. Barium zirconate is present in the ceramic dielectric layer in an amount from about 5% by weight to about 30% by weight. The ceramic dielectric layer can further include a second dopant (e.g., magnesium oxide, calcium oxide, bismuth (III) oxide, or combinations thereof) in an amount of about 0.05% by weight to about 2% by weight of the ceramic dielectric layer.

In a particular embodiment, the ceramic capacitor has a plurality of adjacent pairs of first electrode layers and second electrode layers separated by ceramic dielectric layers in an alternatively stacked arrangement to form a plurality of capacitor elements within the ceramic capacitor (i.e., a multilayer ceramic capacitor).

The present invention is also directed to a method of manufacturing a ceramic capacitor. According to the method, the ceramic dielectric layer described above is formed between a first electrode layer and a second electrode layer. The ceramic dielectric layer can be formed through a slurry prepared by milling a combination of the niobium doped barium titanate, sodium bismuth titanate, and barium zirconate. Each of the niobium doped barium titanate, the sodium bismuth titanate, and the barium zirconate can be, in one particular embodiment, pre-calcined prior to formation of the slurry.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 is a plan cross-sectional view of an exemplary multilayer ceramic capacitor for use in one embodiment of the present invention;

FIG. 2 is a perspective view of an exemplary terminated MLCC such as illustrated in FIG. 1;

FIG. 3 is a plan cross-sectional view of an exemplary multilayer ceramic capacitor for use in an alternate embodiment of the present invention;

FIG. 4 is a plot of the generalized behavior of dielectric constant (K) with temperature for niobium doped barium titanate, sodium bismuth titanate, and barium zirconate;

FIG. 5 is a plot of the variation of dielectric constant with temperature for representative example formulations in disc form, depicting the importance of the quantity of barium zirconate in the formula;

FIG. 6 is a plot of the variation of dielectric constant with temperature for representative example formulations in MLCC form, for example compositions similar to those in FIG. 5;

FIG. 7 is a plot of the variation of dissipation factor (DF) with temperature for representative example formulations in MLCC form, for the example compositions in FIG. 6;

FIG. 8 is a plot of the variation of dielectric constant with temperature for example formulations in MLCC form having additions of various potential acceptor dopants;

FIG. 9 is a plot of the variation of dissipation factor with temperature for the acceptor-doped example compositions in FIG. 8;

FIG. 10 is a plot of the variation of dielectric constant with temperature for example formulations in MLCC form with and without excess bismuth trioxide added; and

FIG. 11 is a plot of the variation of dissipation factor with temperature for the example compositions with and without excess bismuth trioxide added in FIG. 10.

Repeat use of reference characters in the present specification and drawings is intended to represent the same or analogous features or elements of the present invention.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

Generally speaking, the present disclosure is directed to barium titanate based ceramic capacitors having applications at higher temperatures (e.g., greater than about 150° C.), while maintaining minimal performance variations throughout the temperature range of interest. The presently disclosed ceramic capacitors effectively expand the upper temperature limit of X7R capacitors. For example, the presently disclosed dielectric materials offer benefits in high temperature applications over standard barium titanate-based capacitors in one of two ways: (1) by supplying a high dielectric constant at a range of high temperatures above the Curie point of barium titanate and approaching 300° C., thus improving the amount of bulk capacitance available at high temperature, or (2) by providing a moderate dielectric constant changing in a small but steady manner from temperatures near 25° C. to temperatures approaching 300° C., for applications such as filtering or signal processing. Additionally, the presently disclosed dielectric materials can exhibit equivalent or less change in capacitance with applied electric field than standard barium titanate-based capacitor materials throughout the temperature range of interest.

In particular embodiments, the presently disclosed barium titanate based ceramic capacitors offer very stable capacitance (e.g., changing by less than −30% from its peak capacitance) in specified temperature windows starting from about −55° C. to about 300° C. As an example, one embodiment of the presently disclosed ceramic capacitors might peak at 23° C. and show no more than 30% change within the range of −55° C. to 275° C. This would be classified by EIA description more accurately as X9T, where “X” signifies the low end of the range (−55° C.), “9” signifies the upper end of the range (200° C.), and “T” signifies the tolerance over the range (+22/−30% compared to the room temperature value), but the benefits of its moderate capacitance change would be observed well above the defined EIA range. Particular embodiments may also exhibit the same desirable moderate capacitance change over different temperature ranges, with additional benefits of increased dielectric constant and therefore increased capacitance in a given part size. In certain embodiments, the presently disclosed capacitors can offer very stable capacitance in the higher ends of the working temperatures. For instance, the capacitance may change by less than about +/−25% of its capacitance at room temperature in a temperature range from room temperature (e.g., about 25° C.) to about 275° C., such as less than about +/−15% of its capacitance at room temperature in this temperature range.

Ceramic capacitors generally contain a ceramic body having a two or more electrode layers separated by at least one ceramic dielectric layer. Multilayer ceramic capacitors generally contain a ceramic body having a plurality of electrode layers separated by ceramic dielectric layers. The electrode layers in multilayer ceramic capacitors are positioned between the ceramic layers to be internal to the ceramic body.

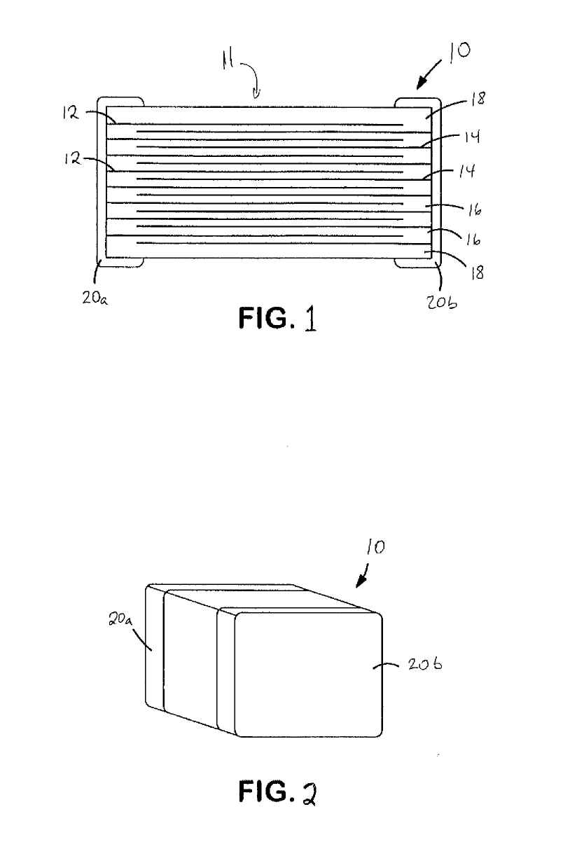

Referring to FIGS. 1-2, for instance, an exemplary multilayer ceramic capacitor (“MLCC”) 10 is shown containing a ceramic body 11 formed from a plurality of stacked layers. As shown, the ceramic body 11 has first electrode layers 12 and second electrode layers 14 separating ceramic dielectric layers 16. The first electrode layers 12 and second electrode layers 14 are alternatively stacked such that each ceramic layer is bounded on one side with a first electrode layer 12 and on the opposite side with a second electrode layer 14. The alternative stacking configuration of the first electrode layers 12 and the second electrode layers 14 results in adjacent pairs of first electrode layers 12 and second electrode layers 14 separated by a ceramic dielectric layer 16. The adjacent pairs of first electrode layers 12 and second electrode layers 14 form opposing parallel capacitor plates.

Each adjacent pair of first electrode layers 12 and second electrode layers 14 forms opposing plates of a capacitor element, with multiple opposing pairs combined in parallel to yield an overall capacitance of the multilayer ceramic capacitor 10. Although eight pairs of first and second electrode layers 12,14 separated by ceramic dielectric layers 16 are illustrated in FIG. 1, it should be appreciated that any number of electrode plates may be utilized in accordance with the present subject matter. For example, the multilayer ceramic capacitor 10 can include from 4 adjacent pairs of electrode layers to 20 adjacent pairs of electrode layers. The number of electrode plates may actually be much higher in some embodiments. Respective first electrode layers 12 and second electrode layers 14 can be formed in a variety of desired shapes, as long as a portion of each first electrode layers 12 is electrically connected to a first peripheral termination 20a and a portion of each second electrode layers 14 is electrically connected to a second peripheral termination 20b to complete the MLCC circuit.

Dielectric cover layers 18 are shown forming the top and bottom surfaces of ceramic body 11 in the exemplary MLCC 10 of FIGS. 1 and 2. These dielectric cover layers 18 can be formed before the peripheral terminations 20a,20b are formed on the MLCC such that the dielectric cover layers 18 and the peripheral terminations 20a,20b combine together to encase the ceramic body 11. However, any suitable configuration of the dielectric cover layers 18 and the peripheral terminations 20a,20b can be utilized.

A perspective view of a finished MLCC after termination is illustrated in FIG. 2. Although the MLCC 10 of the exemplary embodiment shown in FIGS. 1 and 2 is shown to be a substantially rectangular cuboid, the MLCC is not particularly limited to a certain shape or size.

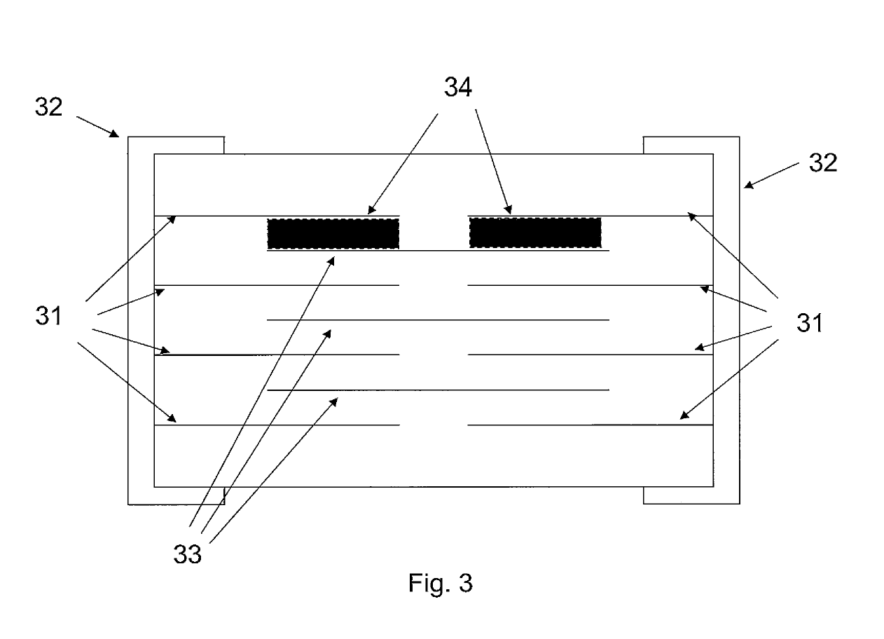

An alternate design for the multilayer capacitor's internal electrodes is shown in FIG. 3. Known as a “floating electrode” or “cascade” design, it differs from the design shown in FIG. 1 in that internal electrodes 31 touching external terminations 32 are coplanar. Capacitance is created by incorporation of an internal “floating” electrode 33 which does not touch either end termination, but ideally overlaps the coplanar electrodes 31 on an adjacent dielectric layer equally. This creates capacitors 34 of approximately equal value in series, effectively doubling the dielectric thickness. Multilayer capacitors of this design have been found to be advantageous in high voltage applications, although volumetric efficiency of capacitance is sacrificed. This effect may be important to the reliability of high temperature capacitors, where the increased operating temperature accelerates the effect of voltage on the useful life of the capacitor.

The presently disclosed ceramic dielectric material is discussed with reference to MLCCs; however, the presently disclosed ceramic dielectric material can be utilized in any electrical component that employs one or more ceramic layers, such as single-layer capacitors, cofired embedded capacitors, resonators, and so forth.

### I. Ceramic Dielectric Layer(s)

The ceramic dielectric layer of the present invention is configured for use of the capacitor at temperatures ranging from about −55° C. to about 300° C., while providing very stable capacitance (e.g., changing by less than −30% from its peak capacitance) within a selected temperature windows within that temperature range (e.g., a device with a peak capacitance at 23° C., exhibiting no more than a 30% capacitance loss from −55° C. to 275° C.). This performance is enabled through a particular combination of barium titanate mixed with other ceramic oxides to provide a ceramic dielectric layer that can sufficiently retain its electrical properties throughout the extended temperature range, especially at elevated temperatures. Thus, the barium titanate-based ceramic dielectic layer can be utilized to form MLCCs having improved performance in relatively high temperature applications while maintaining sufficient performance in the lower temperature applications.

The ceramic dielectric layer includes barium titanate (abbreviated “BT”) having the chemical formula BaTiO₃. BT provides stability to the ceramic dielectric layer throughout the lower end of the working temperature range (i.e., from about −40° C. to about 125° C.). To decrease the transition temperature of the BT-based ceramics, the BT is doped with niobium (Nb) to form niobium doped barium titanate (abbreviated “BT/Nb”). The niobium substitutes in the “B” position (referring to the general ABO₃ chemical structure) for the titanium ions forming a structure BaTi₁₋ₓNbₓO₃ where x ranges from about 0.01 to about 0.2. It should be noted that this doping may not be a true 1 to 1 substitution, so minor variances in the amount of niobium and/or titanium may occur in the actual Nb doped BT.

In the ceramic dielectric layer, the BT/Nb can be present in the ceramic dielectric layer in an amount such that the ceramic dielectric layer comprises from about 5% by weight to about 50% by weight BT based on the weight of BT prior to doping. Also, the ceramic dielectric layer can include niobium from about 0.1% by weight to about 2% by weight, such as from about 0.2% by weight to about 1% by weight, based on the weight of niobium oxide prior to doping. The niobium can be doped into the barium titanate through the addition of any niobium oxide (e.g., niobium (II) oxide having a chemical formula NbO, niobium (IV) oxide having a chemical formula NbO₂, niobium pentoxide having a chemical formula Nb₂O₅, etc.) to barium titanate. For example, niobium can be doped into BT by combining BaTiO₃ and with the desired amount of niobium pentoxide in an aqueous suspension. The amount of niobium pentoxide added can be, for instance, from about 0.5% by weight to about 5% by weight, such as from about 1% by weight to about 3% by weight. A dispersant (e.g., an ammonia based dispersant such as commercially available under the name Tamol 901 from Rohm and Haas, Philadelphia) can be included in the aqueous suspension to aid in processing. The aqueous suspension can then be milled (e.g., using a vibratory mill process) and then dried. The dried material can then be calcined by exposure to extreme temperatures (e.g., from about 900° C. to about 1200° C.) for a period of time, such as for at least an hour (e.g., from about 1.5 hours to about 5 hours) to form pre-calcined Nb-doped BT.

The ceramic dielectric material also includes sodium bismuth titanate (abbreviated “NBT”) in addition to BT/Nb. Without wishing to be believed by theory, it is believed that the NBT generally raises the upper limit of the working temperature range of the ceramic capacitor due to NBT's relatively high T_{C}. The NBT can be present in an amount such that the ceramic dielectric layer includes from about 25% by weight to about 75% by weight NBT, such as from about 30% by weight to about 70% by weight.

The NBT can have a chemical formula: NaₓBi_{y}TiO₃, where x is from about 0.25 to about 0.75 (e.g., from about 0.4 to about 0.6), y is from about 0.25 to about 0.75 (e.g., from about 0.4 to about 0.6), and x+y=1. In one particular embodiment, both x and y can be about 0.5 such that sodium and bismuth are present in substantially stoichiometric equal amounts (e.g., Na_{0.5}Bi_{0.5}TiO₃), which has a T_{C} of about 320° C. These embodiments show that the NBT can include the titanium component (at the “B” position) in its stoichiometric amount without any significant substitution with other ions. Likewise, the NBT composition can be substantially free from substitution in the sodium and/or bismuth components (e.g., at the “A” position).

The NBT can be prepared by combining sodium carbonate, bismuth trioxide, and titanium dioxide in the desired stoichiometric proportions with a solvent (e.g., ethanol) and an optional dispersant (e.g., the dispersant available under the name AKM-0531 from NOF Corp., Japan) to form a slurry. The slurry can then be milled, such as through vibratory milling, and dried to form a dried material. The drying process can utilize, in one embodiment, a rotary evaporator to prevent settling during the drying process and to reclaim the solvent for future use. The dried material can then be ground and calcined at temperatures over about 900° C. (e.g., from about 950° C. to about 1200° C.) for at least an hour to form pre-calcined NBT.

In addition to BT/Nb and NBT, the ceramic dielectric layer includes barium zirconate (abbreviated “BZ”) according to the chemical formula: BaZrO₃. BZ is an antiferroelectric compound without prominent peaks in the dielectric constant and possesses a low dielectric constant (e.g., about 40). Without wishing to be bound by any particular theory, it is believed that the addition of BZ reduces variation of the dielectric constant of the dielectric material through the working temperature range, especially in the upper portion of the temperature range (e.g., above 125° C.).

The BZ can be present in an amount from about 5% by weight to about 30% by weight, such as from about 6% by weight to about 27% by weight in the ceramic dielectric layer. BaZrO₃ can be prepared by combining aqueous suspensions of BaCO₃ and ZrO₂, with the use of an optional dispersant (e.g., Tamol 901 available from Rohm and Haas, Philadelphia), to create a slurry. The resulting slurry can be milled and dried. Finally, the dried material can be calcined at temperatures over about 900° C. (e.g., from about 950° C. to about 1200° C.) for at least an hour for form pre-calcined BZ.

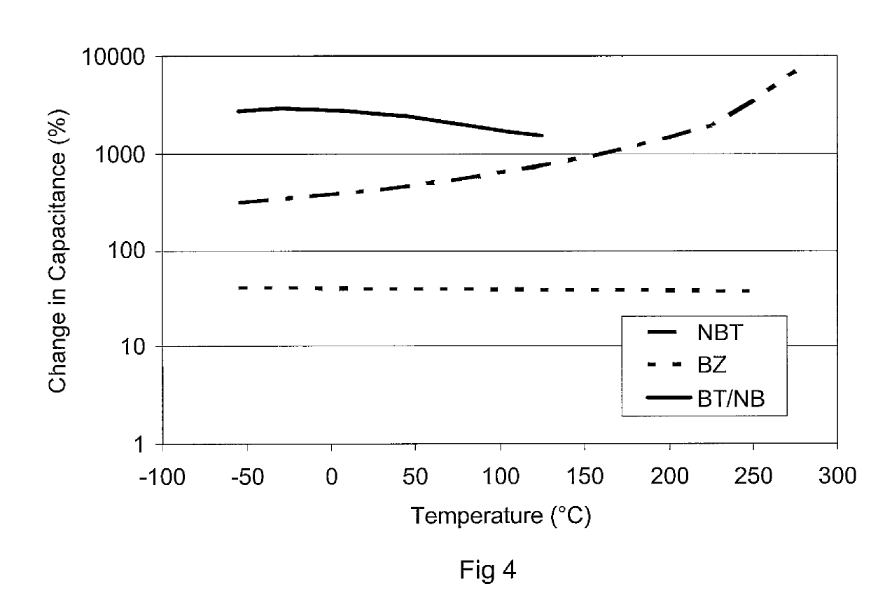

FIG. 4 shows schematically the relationship of the dielectric constants for each of these starting components at varying temperature. The BT/Nb has a relatively high dielectric constant at low temperatures, which drops considerably as temperature increases. The NBT behaves in the opposite manner, providing increased capacitance at high temperatures. The BZ shows a very flat behavior by comparison, theoretically moderating the performance of the BT/Nb and the NBT.

Since each of these ceramic oxides can be individually calcined through thermal treatment processes to provide pre-calcined ceramic oxides for the ceramic dielectric layer, the quality of each material, including crystal structure and impurity levels, can be tightly controlled. For example, one and/or all of the ceramic oxides can be substantially free from impurities (e.g., greater than about 99.5% pure), and one and/or all of the materials can be provided with fine grain sizes (e.g., from about 0.1 micron to about 0.5 microns). Such fine grain sizes may allow intimate reaction and enhanced sintering in the final product.

The pre-calcined ceramic oxides BT/Nb, NBT, and BZ can be readily combined together (e.g., milled) to form a slurry using a solvent that includes, but is not limited to, water, ethanol, acetates, toluene, etc., and mixtures thereof. Of course, any suitable solvent can be utilized. The combination of these ceramic oxides can form a ceramic material having a general ABO₃ structure with the chemical formula:

Na_{1-x-y}BiₓBa_{y}Ti_{1-a-b}ZrₐNb_{b}O₃

where the “A” positions are occupied by the Na, Bi, and Ba ions and the “B” positions are occupied by the Ti, Zr, and Nb ions and where 0.2≦x≦0.5, 0<y≦0.7, 0<a≦0.7, and 0<b≦0.2.

The use of pre-calcined ceramic oxides combined in a slurry also allows for the inclusion of other dopants into the ceramic dielectric layer formed from the ceramic oxide components. Other dopants can be included in the dielectric layer to adjust certain properties of the ceramic dielectric layer (e.g., resistance). These additional dopants can include, but are not limited to, magnesium oxide (MgO), calcium oxide (CaO), bismuth (III) oxide (Bi₂O₃), and combinations thereof. These dopants can be present in the ceramic dielectric layer up to about 2% by weight, such as from about 0.05% by weight to about 1% by weight of the dielectric material based on the weight of the added dopant composition. For example, in one particular embodiment, magnesium oxide can be added to the ceramic dielectric layer up to about 0.1% by weight, such as from about 0.02% by weight to about 0.09% by weight. Additionally, or alternatively, calcium oxide can be added to the ceramic dielectric layer up to about 0.5% by weight, such as from about 0.2% by weight to about 0.3% by weight. In another embodiment, bismuth (III) oxide can be added, in addition to other dopants or in the alternative to other dopants, to the ceramic dielectric layer in amounts up to about 1% by weight, such as from about 0.75% by weight to about 1% by weight. These additional dopants can be added to the slurry containing the ceramic oxides.

Binders and/or plasticizers can be added to the slurry to create a slip for forming the ceramic dielectric layer. Suitable binders include, but are not limited to, camphor, stearic and other soapy fatty acids, Glyptal (General Electric), polyvinyl alcohols, polyvinyl alcohols, polyethylene glycols, polyvinyl butyrals, celluloses, napthaline, vegetable wax, and microwaxes (purified paraffins). The binder may be dissolved and dispersed in a solvent. Exemplary solvents may include acetone; methyl isobutyl ketone; trichloromethane; fluorinated hydrocarbons (freon) (DuPont); alcohols; toluene, mineral spirits, and chlorinated hydrocarbons (carbon tetrachloride). When utilized, the percentage of binders and/or lubricants may vary from about 0.1% to about 12% by weight of the total mass of the slurry.

The ceramic body for use in a multilayer ceramic capacitor can be formed according to any process. For instance, a wet laydown process, as is known in the art, can be utilized to form the ceramic body from the slurry of the ceramic oxides. According to the wet laydown process, the slurry is applied to a coated glass plate and then dried. The first electrode layers 12 and the second electrode layers 14 can be created by printing (e.g., screen printing) the electrode patterns at intervals during the buildup of the dielectric layers in a manner that creates an alternating pattern, such as shown in FIG. 1 or FIG. 3. Several layers of the ceramic dielectric can be applied between each electrode, to reduce the effect of any potential defects in one of the dielectric layers by filling such defects with the following dielectric layer. This process can be repeated to form a MLCC having the desired number of active layers (e.g., pairs of first electrode layers 12 and second electrode layers 14 separated by a ceramic dielectric layer 16.

After the wet laydown process is completed, the resulting material can be diced into individual capacitors using any convenient dicing (e.g., a wet dicing technique). Then, the individual capacitors can be removed from the glass plate. The corners of the individual capacitors can be rounded, if desired, through any process, such as tumbling the capacitors in water. Finally, the binder can be removed from the capacitors by slowly heating to a moderate temperature, depending on the binder used (e.g., about 400° C.). Then, the capacitors can be fired in the range of about 1100° C. to about 1200° C. (e.g., from about 1125° C. to about 1175° C.) for at least one hour, such as from about 1.5 hours to about 5 hours.

In addition to the ceramic dielectric layers 16, dielectric cover layers 18 can be formed to define outer borders of the stacked ceramic dielectric layers and electrode layers. In one particular embodiment, the dielectric cover layers 18 are constructed from the same material as the ceramic dielectric layers to facilitate the manufacturing process.

### II. Electrode Layers

As stated above, the ceramic body has first electrode layers 12 and second electrode layers 14 separating the ceramic dielectric layers 16. The first electrode layers 12 and second electrode layers 14 are alternatively stacked such that each ceramic layer is bounded on one side with a first electrode layer 12 and on the opposite side with a second electrode layer 14. The alternative stacking configuration of the first electrode layers 12 and the second electrode layers 14 results in adjacent pairs of first electrode layers 12 and second electrode layers 14 separated by a ceramic dielectric layer 16. The adjacent pairs of first electrode layers 12 and second electrode layers 14 form opposing parallel capacitor plates.

The electrode layers 12 and 14 may be formed from copper, nickel, aluminum, palladium, gold, silver, platinum, lead, tin, alloys of these materials, or any other suitable conductive substance.

The material used to construct the first electrode layers 12 and the second electrode layers 14 can be, in one embodiment, configured to withstand high temperatures that may be encountered when firing the ceramic body 11 for use in MICCs. For example, the ceramic body 11 can be exposed to temperatures over 1000° C. (e.g., from about 1100° C. to about 1200° C.) during firing. Certain metal combinations may not be suitable for such elevated firing temperatures. For instance, pure copper or aluminum, silver, lead, gold, or tin melt at too low a temperature, while Ni would oxidize in most air firing applications. Electrode layers constructed from 70% palladium and 30% silver may also result in melted electrodes at 1150° C. and above. Pure palladium and platinum would be stable for this application, but are expensive and may suffer undesirable reactions with bismuth-bearing compounds at the firing temperature. As such, in certain embodiments, alloys can be used to provide sufficient stability and the desired conductivity while still remaining cost effective. Additionally, the first electrode layers 12 and second electrode layers 14 can be constructed, in one embodiment, to be lead-free due in part to its relatively low melting point.

In one particular embodiment, the first electrode layers 12 and the second electrode layers 14 can be made from metal material containing platinum. For example, a metal material containing a combination of palladium, silver, and platinum from about 1% by weight to about 10% by weight can be used to from the first electrode layers 12 and the second electrode layers 14.

### III. Terminations

In the exemplary embodiment shown in FIGS. 1 and 2, the first peripheral termination 20a electrically connects to each first electrode layer 12, and the second peripheral termination 20b electrically connects to each second electrode layer 14. The terminations 20a and 20b are generally attached to lead wires to connect the MLCC 10 to the electrical circuit.

Terminations 20a and 20b may also include one or more layers of conductive materials. Terminations 20a and 20b can be, for example, formed from copper, nickel, aluminum, palladium, gold, silver, platinum, lead, tin, alloys of these materials, or any other suitable conductive substance. In one embodiment, multilayer terminations are employed that include a first layer of copper, a second solder-barrier layer of nickel, and a third layer corresponding to one or more of Ni, Ni/Cr, Ag, Pd, Sn, Pb/Sn, alloys of these materials or other suitable plated solder. One particular embodiment involves a glass bearing metal (e.g., silver) composite with may be soldered to directly (i.e., no plating).

### Examples

### A. Preparation of Raw Materials

High purity fine grained Nb-doped BaTiO₃ was prepared by combining fine grained high purity BaTiO₃ (HQBT-15) and with a 2 wt % addition of reagent-grade Nb₂O₅ in an aqueous suspension with Tamol 901 dispersant as needed. The slurry was milled using a vibratory mill and then dried. The dried material was then loaded into saggers and calcined at 1000° C. for 2 hrs in a furnace. After calcining, the Nb-doped BaTiO₃ was removed from the saggers and pulverized via hammer milling. X-ray diffraction, SEM analysis and other characterization techniques were used to insure only the correct crystal phase was present in the material and that the grain size was appropriate for further work.

High purity fine grained Na_{0.5}Bi_{0.5}TiO₃ was prepared by combining high purity sodium carbonate, bismuth trioxide, and titanium dioxide in the correct stoichiometric proportions with reagent grade ethanol and a dispersant (NOF AKM-0531) to form a slurry and milling the slurry in a vibratory mill. The slurry was dried using a rotary evaporator to prevent settling during the drying process and to reclaim the ethanol for future use. The dried cake was broken up and loaded into alumina saggers for calcining. The ground Na_{0.5}Bi_{0.5}TiO₃ cake was calcined at 950° C. for 2 hrs in a furnace. After calcining, the Na_{0.5}Bi_{0.5}TiO₃ was removed from the saggers and pulverized via hammer mill. X-ray diffraction, SEM analysis and other characterization techniques were used to insure only the correct crystal phase was present in the material and that the grain size was appropriate for further work.

High purity fine grained BaZrO₃ was prepared by first preparing aqueous suspensions of ultrafine BaCO₃ and ZrO₂, using Tamol 901 dispersant as needed. These were milled and blended in a horizontal bead mill. The combined slurry was then dried, and then loaded into saggers and calcined at 1050° C. for 3 hrs in a furnace. After calcining, the BaZrO₃ was removed from the saggers and pulverized via hammer milling. X-ray diffraction, SEM analysis and other characterization techniques were used to insure only the correct crystal phase was present in the material and that the grain size was appropriate for further work.

### B. Chemical Formulation Testing

Disc tests were conducted using the above raw materials to determine potential K values and capacitance-temperature characteristics. A list of the compositions examined can be found in Table 1:

TABLE 1

| Example | Wt % of Component | | | |
|---|---|---|---|---|
| Number | (Bi0.5Na0.5)TiO3 | BaZrO3 | BaTiO3 | Nb2O5 |
| 1 | 100 | | | |
| 2 | 25 | 75 | — | — |
| 3 | 50 | 50 | — | — |
| 4 | 75 | 25 | — | — |
| 5 | 67.5 | 22.5 | 9.8 | 0.2 |
| 6 | 60 | 20 | 19.6 | 0.4 |
| 7 | 52.5 | 17.5 | 29.4 | 0.6 |
| 8 | 43.75 | 26.25 | 29.4 | 0.6 |
| 9 | 37.5 | 22.5 | 39.2 | 0.8 |
| 10 | 31.25 | 18.75 | 49 | 1 |
| 11 | 45 | 15 | 39.2 | 0.8 |
| 12 | 37.5 | 12.5 | 49 | 1 |
| 13 | 61.25 | 8.75 | 29.4 | 0.6 |
| 14 | 52.5 | 7.5 | 39.2 | 0.8 |
| 15 | 43.75 | 6.25 | 49 | 1 |

To prepare each composition, aqueous slurries were prepared of the NBT, BZ, and BT/Nb via vibratory milling. The solids content of each slurry was measured and the correct amounts of each component slurry were mixed together to yield the experimental composition. Each compositional slurry was dried, mixed with binder and granulated. The granulated materials were pressed into 0.5″ diameter discs approximately 25-30 mils thick. The discs were fired in closed ZrO₂ saggers at 1150-1200° C. for 2 hrs in an air atmosphere.

Three samples for each experimental coating were electroded with gold-palladium thin film metallization, followed by a conductive epoxy coating.

For each disc sample, capacitance and dissipation factor at 1 KHz and 1 V were measured. Following this, the capacitance and dissipation factor with temperature were measured at varying temperatures. Peak temperature was determined by measurements from −55° C. to 150° C. Following representative compositions were measured at temperatures up to 275° C. to understand the entire range of variation.

Table 2 shows key property measurements for the samples listed above.

TABLE 2

| | | Peak K | | | | |
|---|---|---|---|---|---|---|
| | | Temper- | | | | |
| Example | K at | ature | | K at | K at | K at |
| No. | 25° C. | (° C.) | K at Peak | 150° C. | 200° C. | 250° C. |
| 1 | 420 | >300 | >16500 | 924 | 1461 | 3467 |
| 2 | 137 | 25 | 137 | 135 | — | — |
| 3 | 500 | 45 | 500 | 485 | — | — |
| 4 | 1187 | 85 | 1550 | 1549 | — | — |
| 5 | 1363 | 83.4 | 1660 | 1614 | — | — |
| 6 | 1366 | 74.1 | 1570 | 1498 | — | — |
| 7 | 1468 | 69 | 1583 | 1538 | 1285 | 1203 |
| 8 | 878 | 37.2 | 880 | 816 | — | — |
| 9 | 942 | 28 | 943 | 870 | 825 | 760 |
| 10 | 890 | 14.7 | 891 | 797 | — | — |
| 11 | 1339 | 57.7 | 1420 | 1402 | — | — |
| 12 | 1355 | 43.4 | 1312 | 1313 | — | — |
| 13 | 1295 | 92.6 | 2200 | 1175 | — | — |
| 14 | 1548 | 84.4 | 2066 | 2065 | 2052 | 1927 |
| 15 | 1615 | 71.1 | 1835 | 2011 | — | — |

Examples 1-4 are comparative samples which depict the behavior of NBT alone and in combination with BZ. Example 1 shows the large increase in dielectric constant (K) at high temperatures for NBT, exceeding 1400 at 200° C. and peaking above 300° C., as expected. Examples 2 through 4 indicate the strong moderating effect which BZ has on NBT. When BZ is added, the peak temperature of K is shifted to below 150° C., is created in the K versus temperature curve, with either flat or gently declining K variation above the peak and a steep drop below the peak. Additional BZ only serves to reduce the dielectric constant at all temperatures, although the scale of the peak is reduced.

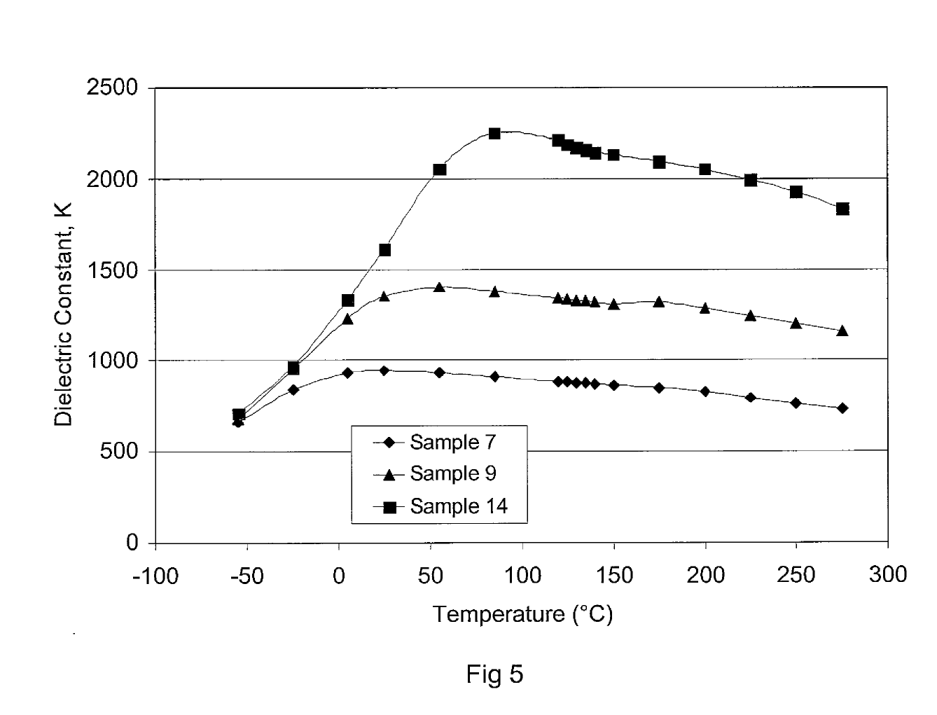

Examples 5 through 15 show the performance of varying combinations of NBT, BT/Nb, and BZ. Incorporation of barium titanate in the formulation has the effect of increasing the overall dielectric constant, and broadening the range over which flat performance is observed while maintaining relatively high K. FIG. 5 shows the measured dielectric constant versus temperature for 3 representative examples (7, 9, 14) indicating the range of K variation that can be observed. From this figure, it can be seen that the variation of K with temperature can be advantageously modified to suit a given application, ranging from flat performance over a broad range of temperatures, to providing large stable capacitance only at high temperature.

### C. MLCC Testing

MLCCs were prepared from the following compositions using a wet laydown process. Compositions were selected based on the three components listed above (i.e., BT/Nb, NBT, and BZ). In addition, minor dopants were introduced to the three components to control the density, insulation resistance, and reliability under bias. A list of the compositions examined can be found in Tables 3a and 3b:

TABLE 3a

| Example | Wt % of Component | | | | | | | | |
|---|---|---|---|---|---|---|---|---|---|
| No. | NBT | BZ | BT | Nb2O5 | MnO | MgO | NiO | CaO | Bi2O3 |
| 16 | 52.50 | 17.50 | 29.40 | 0.60 | | — | | — | — |
| 17 | 52.50 | 17.50 | 29.40 | 0.60 | | — | | — | — |
| 18 | 31.25 | 18.75 | 49.00 | 1.00 | | — | | — | — |
| 19 | 52.50 | 7.50 | 39.20 | 0.80 | | — | | — | — |
| 20 | 37.46 | 12.49 | 48.95 | 1.00 | 0.10 | | | | |
| 21 | 37.48 | 12.49 | 48.97 | 1.00 | | 0.06 | | — | — |
| 22 | 37.46 | 12.49 | 48.95 | 1.00 | | | 0.11 | | |
| 23 | 37.45 | 12.48 | 48.93 | 1.00 | | — | | 0.14 | — |
| 24 | 51.98 | 17.33 | 29.11 | 0.59 | | — | | — | 0.99 |

TABLE 3b

| Example | | |
|---|---|---|
| No. | Electrode | Construction |
| 16 | 70Pd/30Ag | Floating |
| 17 | 28Pd/66Ag/6Pt | Floating |
| 18 | 28Pd/66Ag/6Pt | Floating |
| 19 | 28Pd/66Ag/6Pt | Floating |
| 20 | 28Pd/66Ag/6Pt | Floating |
| 21 | 28Pd/66Ag/6Pt | Floating |
| 22 | 28Pd/66Ag/6Pt | Floating |
| 23 | 28Pd/66Ag/6Pt | Floating |
| 24 | 28Pd/66Ag/6Pt | Std |

Combinations of the ceramic components were added to a vibratory mill containing a combination of solvents and a dispersant compatible with all of the ceramic components. Each composition was milled approximately 24 hrs, following which the slurry was removed from the media. A standard polyvinyl butyral-based binder/plasticizer combination was added, along with additional solvent, to create a slip.

Multilayer ceramic devices (either cascade or standard designs, as indicated in Table 3) were constructed with these slips using a wet laydown process, in which layers of slip are applied to a coated glass plate and dried. Active layers were created by screen printing electrode patterns at intervals during the buildup of the layers, in a manner that creates typical alternating patterns found in the multilayer ceramic capacitors depicted in FIGS. 1-3. Multiple layers of dielectric were applied between each electrode print, insuring potential defects in one layer were filled by the following applied layer. Each device was constructed of a minimum of 8 active layers.

After the wet laydown process was completed, the ceramic body was diced into individual capacitors. Then, the parts were removed from the glass plate and tumbled in water to round the corners, and dried.

The parts were loaded into ZrO₂ boats and the binders removed by slowly heating the parts in air to 400° C. Then, the parts were fired in the range of 1125 to 1175° C. for 2 hrs in air. The ZrO₂ boats were fired in stacks with the top boat covered to reduce the amount of Bi₂O₃ lost by evaporation during firing.

Internal electrodes with two different metal compositions were tested (see Table 4 and samples 16 and 17), the first containing 70% palladium and 30% silver (by weight), and the second containing 28% palladium, 66% silver and 6% platinum (by weight). It was determined that 70% Pd/30% Ag composition resulted in melted electrodes at 1150° C. and above, while the 28% Pd/66% Ag/6% Pt composition gave stable electrodes at 1150° C. The Pt-doped electrode was therefore preferred for these experiments.

Following firing, the parts were corner-rounded using standard harperization techniques, then terminated with fired-on silver paste. The terminated parts were tested for capacitance (dielectric constant) and dissipation factor at 1 KHz and 1 Vac, insulation resistance at 6 Vdc/μm at 25° C., 200° C., and 265° C., and dielectric constant and dissipation factor vs. temperature at 1 KHz and 1 Vac from −55° C. to 275° C.

Table 4a summarizes the electrical room temperature properties for these examples, and Table 4b shows the same properties at 200° C. and 265° C.:

TABLE 4a

| | 25° C. | | |
|---|---|---|---|
| Example | | | RC Product |
| No. | K | DF (%) | (ohm-F) |
| 16 | Melted Electrodes | | |
| 17 | 1735 | 8.81 | 6,012 |
| 18 | 1178 | 1.17 | 1883 |
| 19 | 1764 | 11.42 | 431 |
| 20 | 1331 | 3.39 | 471 |
| 21 | 1558 | 4.39 | 1,888 |
| 22 | 1623 | 4.52 | 1,086 |
| 23 | 1643 | 4.26 | 2,768 |
| 24 | 1451 | 7.69 | 29305 |

TABLE 4b

| | 200° C. | | | | 265° C. | | | |
|---|---|---|---|---|---|---|---|---|
| | Change | | | RC Product | Change | | | RC Product |
| Example No. | in K (%) | K | DF (%) | (ohm-F) | in K (%) | K | DF (%) | (ohm-F) |
| 16 | Melted Electrodes | | | | Melted Electrodes | | | |
| 17 | 1.1 | 1754 | 0.03 | 88 | −5.9 | 1633 | 0.29 | 2.0 |
| 18 | −18.7 | 2273 | 0.15 | 111 | −26.4 | 2094 | 0.76 | 1.8 |
| 19 | 30.2 | 958 | 0.07 | 79 | 22.7 | 867 | 0.21 | 1.4 |
| 20 | −13.5 | 1152 | 0.15 | 33 | −20.5 | 1058 | 0.45 | 0.6 |
| 21 | −22.0 | 1215 | 0.15 | 1321 | −32.0 | 1059 | 0.48 | 20.1 |
| 22 | −20.5 | 1291 | 0.15 | 1291 | −29.3 | 1147 | 0.44 | 44.1 |
| 23 | −24.4 | 1242 | 0.23 | 162 | −33.1 | 1099 | 0.65 | 2.6 |
| 24 | −2.62 | 1433 | 0.07 | 165 | −11.15 | 1308 | 0.35 | 2.5 |

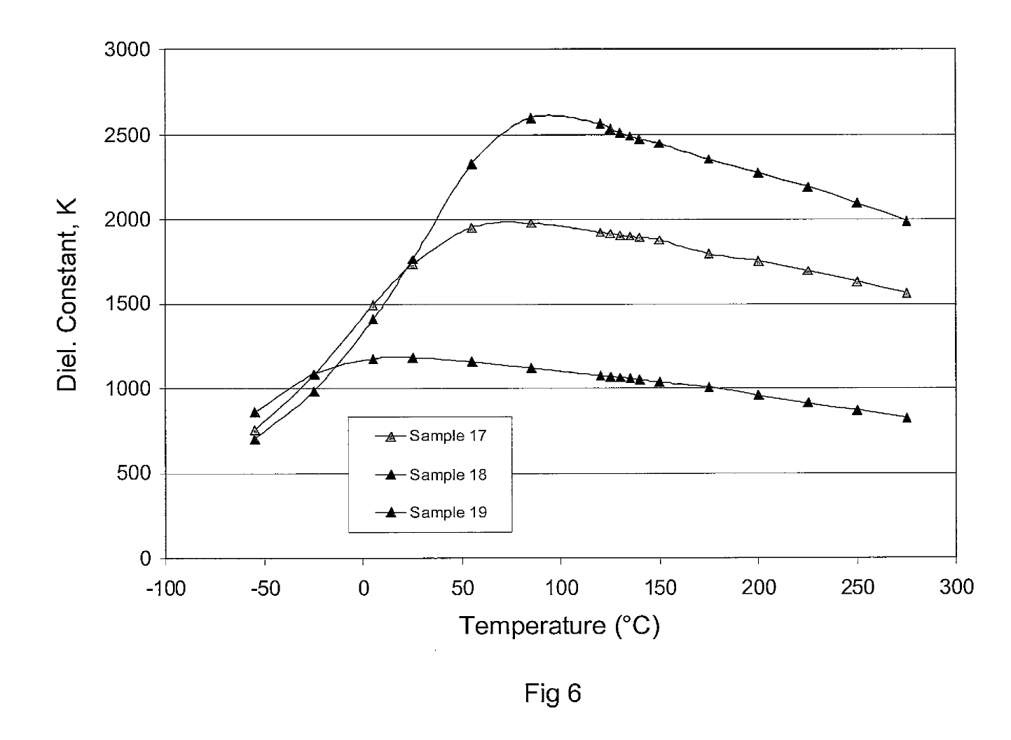

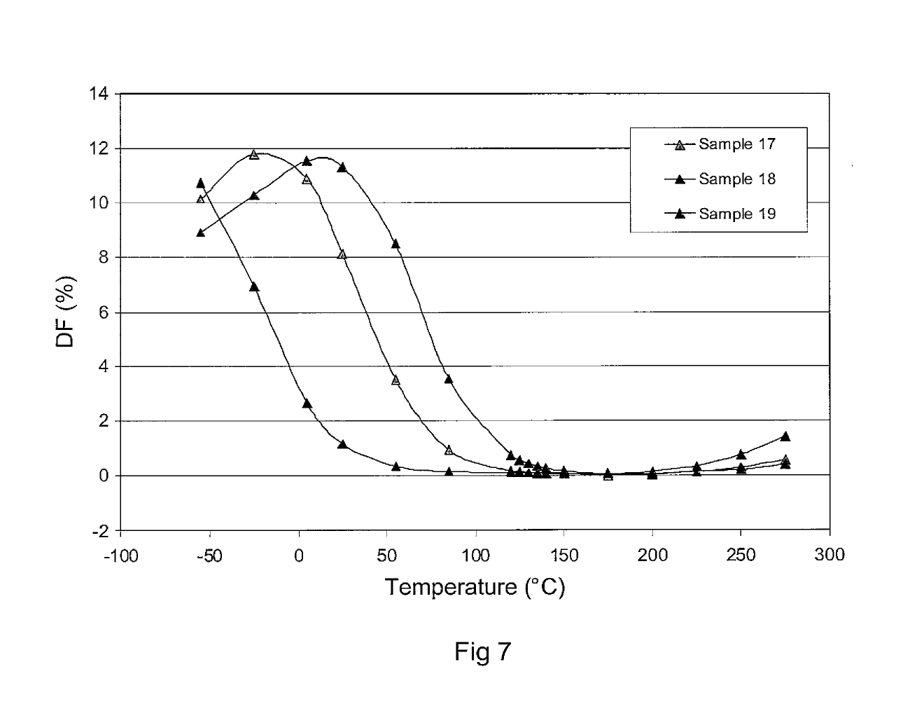

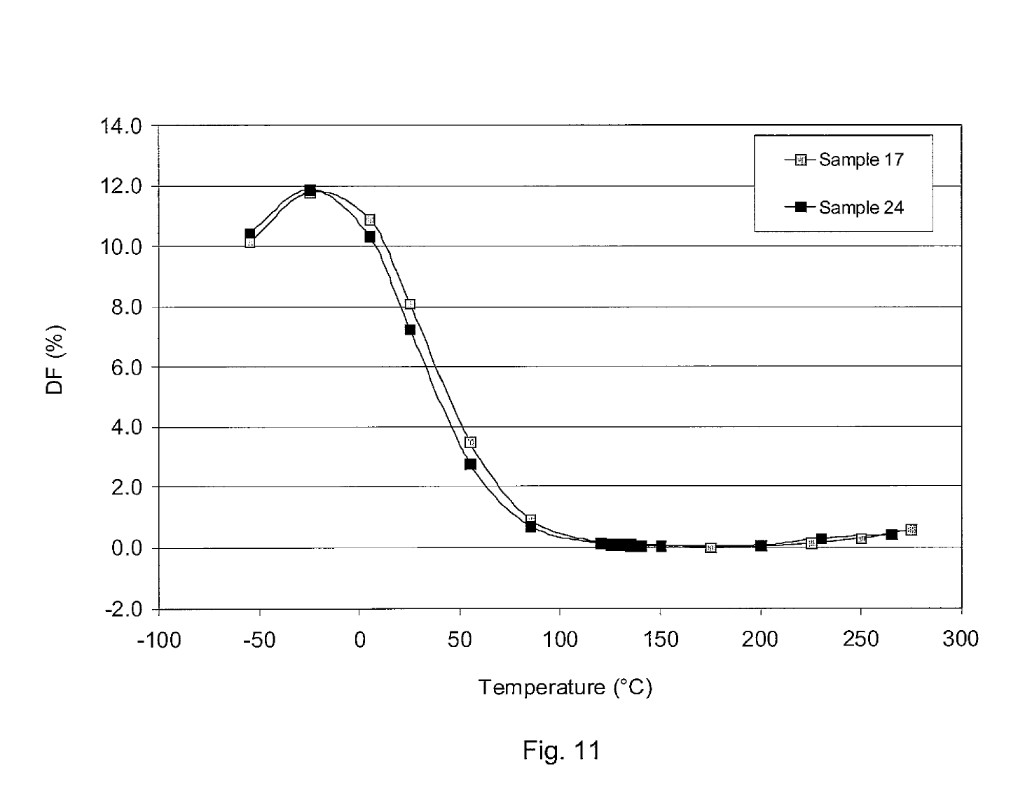

FIGS. 6 through 11 summarize the variation of dielectric constant and dissipation factor with temperature for the examples. By examining the performance of Examples 17, 18, and 19, it can be seen that the temperature dependence of dielectric constant noted in the disc samples was generally repeated in the MLCC form and that the dissipation factor for all of these samples at high temperatures was generally below 1%. RC products for examples 17, 18 and 19 were near 100 ohm-cm at 200° C., and above 1 ohm-cm at 265° C. These results indicate that MLCC devices can be prepared with acceptable high temperature device properties, whose variation of K with temperature can be advantageously modified to suit a given application, ranging from flat performance over a broad range of temperatures, to providing large stable capacitance only at high temperature.

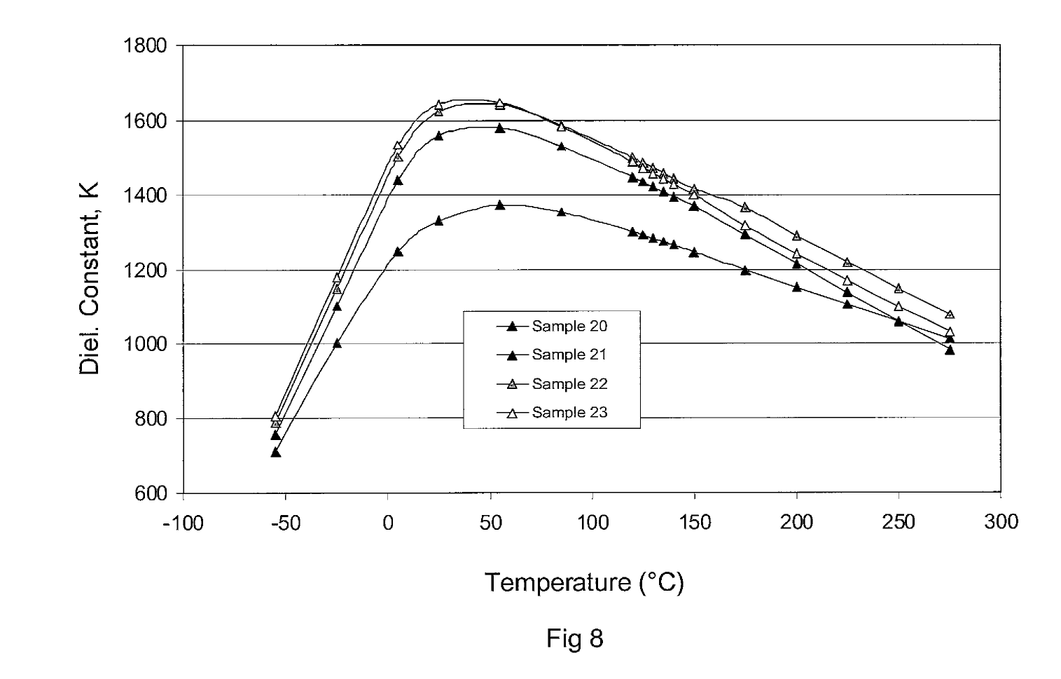

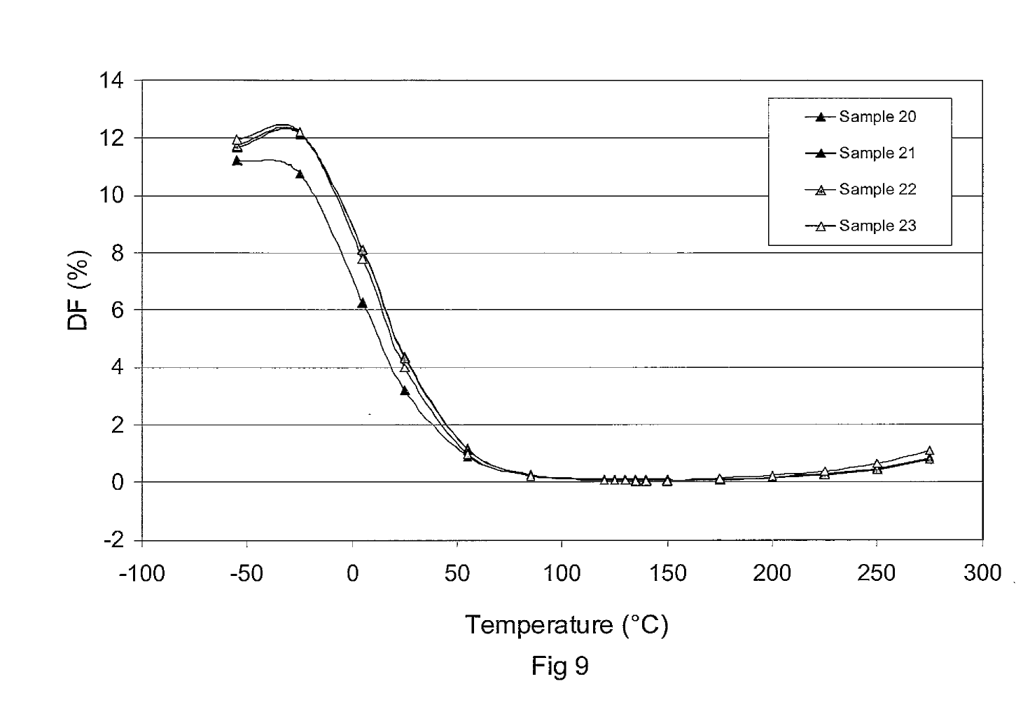

Examples 20, 21, 22 and 23 indicate the benefits of small quantities of acceptor dopants in these formulations. These examples were prepared with small amounts of manganese (MnCO₃), magnesium (MgO), nickel (NiO) and calcium (as CaCO₃) added at the point of blending the NBT, BT/Nb and BZ components. The major effect of these dopants was noted in insulation resistance, as shown in the RC products found in Table 4. Of these, manganese in the quantity used here showed degradation of the insulation resistance. Magnesium and nickel showed substantial increases in the high temperature resistance, increasing RC by a factor of 10. Calcium also showed a modest increase in RC as well. Little influence was observed in the variation of K and DF with temperature for magnesium, nickel and calcium as shown in FIGS. 8 and 9. The manganese addition caused a small loss in K and a slightly lower DF. Therefore, it can be surmised that acceptor dopants are generally advantageous for reducing insulation resistance, particularly magnesium, nickel and calcium.

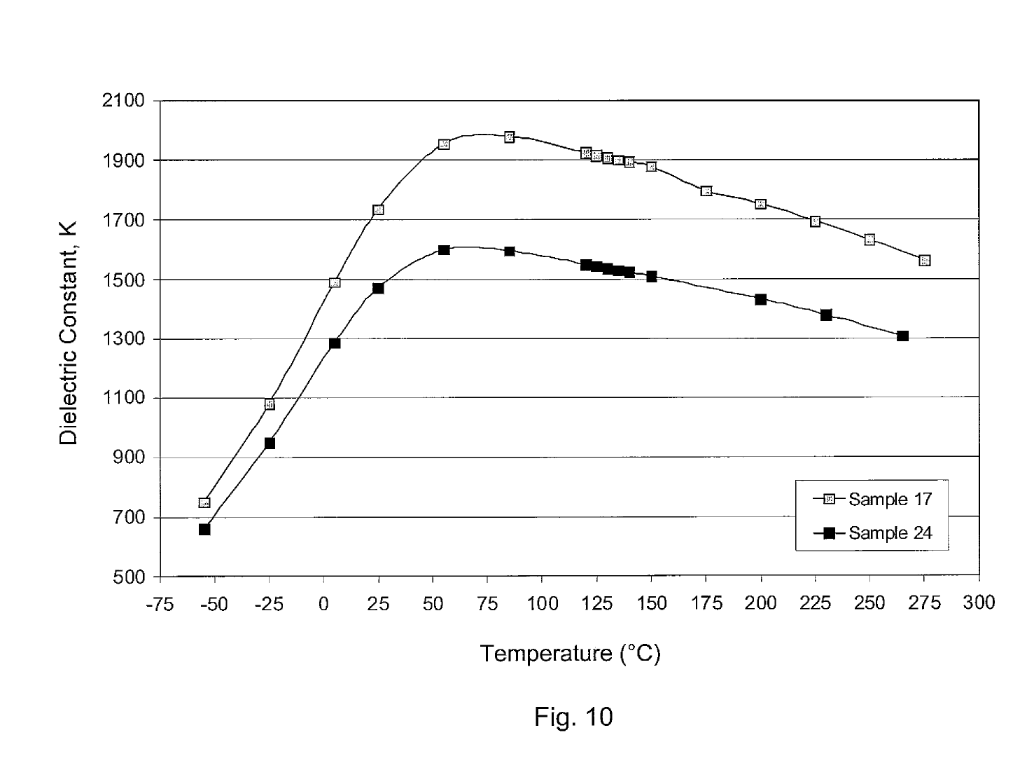

Example 24 (in conjunction with Example 17) demonstrates the generally beneficial effect of a small bismuth addition (as Bi₂O₃), added at the point of blending the NBT, BT/Nb and BZ components). In this comparison, it can be seen that the insulation resistance, as indicated by the RC product, improves at both room temperature and high temperature when approximately 1 wt % of Bi₂O₃ is added. It is likely that this material compensated for bismuth evaporation occurring during the firing process, reducing the point defects in the crystal structure. FIG. 10 shows the variation of K and DF with firing temperature for Examples 17 and 24. The bismuth addition appeared to reduce the overall dielectric constant performance, but had little effect on the dissipation factor. Because RC increased even though dielectric constant was lower, it can be surmised that Bi₂O₃ additions are advantageous in improving the insulation resistance of the material.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A ceramic capacitor comprising a ceramic dielectric layer positioned between a first electrode layer and a second electrode layer, wherein the ceramic dielectric layer comprises niobium doped barium titanate, sodium bismuth titanate, and barium zirconate, wherein the niobium doped barium titanate is present in an amount such that the ceramic dielectric layer comprises from about 5% by weight to about 50% by weight barium titanate and from about 0.1% by weight to about 2% by weight niobium based on the weight of niobium material added, wherein the sodium bismuth titanate is present in the ceramic dielectric layer in an amount from about 25% by weight to about 75% by weight, and wherein barium zirconate is present in the ceramic dielectric layer in an amount from about 5% by weight to about 30% by weight.

2. The ceramic capacitor of claim 1, wherein sodium bismuth titanate comprises: NaₓBi_{y}TiO₃, where x is from about 0.25 to about 0.75, y is from about 0.25 to about 0.75, and x+y=1.

3. The ceramic capacitor of claim 1, wherein sodium bismuth titanate comprises Na_{0.5}Bi_{0.5}TiO₃.

4. The ceramic capacitor of claim 1, wherein the ceramic dielectric layer further comprises a second dopant.

5. The ceramic capacitor of claim 4, wherein the second dopant comprises magnesium oxide, calcium oxide, bismuth (III) oxide, or combinations thereof.

6. The ceramic capacitor of claim 4, wherein the second dopant is present in the ceramic dielectric layer from about 0.05% by weight to about 2% by weight.

7. The ceramic capacitor of claim 1 comprising a plurality of adjacent pairs of first electrode layers and second electrode layers separated by ceramic dielectric layers in an alternatively stacked arrangement to form a plurality of capacitor elements within the ceramic capacitor.

8. The ceramic capacitor of claim 7 comprising from 4 adjacent pairs of first electrode layers and second electrode layers separated by ceramic dielectric layers to 20 adjacent pairs of first electrode layers and second electrode layers separated by ceramic dielectric layers.

9. The ceramic capacitor of claim 7 comprising 8 adjacent pairs of first electrode layers and second electrode layers separated by ceramic dielectric layers.

10. The ceramic capacitor of claim 7 further comprising a first dielectric cover layer and a second dielectric cover layer.

11. The ceramic capacitor of claim 7 further comprising a first peripheral termination connected to each first electrode layer; and a second peripheral termination connected to each second electrode layer.

12. The ceramic capacitor of claim 1, wherein the first electrode layers and the second electrode layers comprise a metal material containing platinum from about from about 1% by weight to about 10% by weight.

13. The ceramic capacitor of claim 1, wherein each of the niobium doped barium titanate, sodium bismuth titanate, and barium zirconate have a grain size of about 1 micron to about 5 microns.

14. A method of manufacturing a ceramic capacitor, the method comprising
forming a ceramic dielectric layer between a first electrode layer and a second electrode layer, wherein the ceramic dielectric layer comprises niobium doped barium titanate, sodium bismuth titanate, and barium zirconate, wherein niobium doped barium titanate is present in an amount such that the ceramic dielectric layer comprises from about 5% by weight to about 50% by barium titanate and from about 0.1% by weight to about 2% by weight niobium based on the weight of niobium material added, wherein sodium bismuth titanate is present in the ceramic dielectric layer in an amount from about 25% by weight to about 75% by weight, and wherein barium zirconate is present in the ceramic dielectric layer in an amount from about 5% by weight to about 30% by weight.

15. The method of claim 14 further comprising
milling a slurry of niobium doped barium titanate, sodium bismuth titanate, and the barium zirconate to provide a slurry for forming the ceramic dielectric layer.

16. The method of claim 14 further comprising
milling a slurry of pre-calcined niobium doped barium titanate, pre-calcined sodium bismuth titanate, and pre-calcined barium zirconate to provide a slurry for forming the ceramic dielectric layer.

17. The method of claim 16 further comprising
combining barium titanate and a niobium oxide in an aqueous suspension;
milling the aqueous suspension to form a milled aqueous suspension;
drying the milled aqueous suspension to form a dried material; and
heating the dried material to temperatures from about 900° C. to about 1200° C. for at least one hour to form pre-calcined niobium doped barium titanate.

18. The method of claim 16 further comprising
combining sodium carbonate, bismuth trioxide, and titanium dioxide with a solvent to form a slurry;
milling the slurry to form a milled slurry;
drying the milled slurry to form a dried material; and
heating the dried material to temperatures from about 900° C. to about 1200° C. for at least one hour to form pre-calcined sodium bismuth titanate.

19. The method of claim 18, wherein sodium carbonate, bismuth trioxide, and titanium dioxide are combined in stoichiometric amounts to provide sodium bismuth titanate having a chemical formula: NaₓBi_{y}TiO₃, where x is from about 0.25 to about 0.75, y is from about 0.25 to about 0.75, and x+y=1.

20. The method of claim 16 further comprising
forming an aqueous suspension containing barium zirconate;
milling the aqueous suspension to form a milled aqueous suspension;
drying the milled aqueous suspension to form a dried material; and
heating the dried material to temperatures from about 900° C. to about 1200° C. for at least one hour to form the pre-calcined barium zirconate.
